(19) United States
(12) Patent Application Publication
(10) Pub. No.: US 2013/0117368 A1
(43) Pub. Date: May 9, 2013

(54) ONLINE LEARNING COLLABORATION SYSTEM AND METHOD

(71) Applicants: Linda T. Dozier, Great Falls, VA (US); Richard S. Shoemake, Nonthaburi (TH); Arthur B. Clifford, Lompoc, CA (US)

(72) Inventors: Linda T. Dozier, Great Falls, VA (US); Richard S. Shoemake, Nonthaburi (TH); Arthur B. Clifford, Lompoc, CA (US)

(73) Assignee: EPALS, INC., Herndon, VA (US)

(21) Appl. No.: 13/605,420

(22) Filed: Sep. 6, 2012

Related U.S. Application Data
(60) Provisional application No. 61/531,614, filed on Sep. 6, 2011.

(51) Int. Cl. H04L 29/06

(52) U.S. Cl. CPC H04L 65/403
USPC 709/204

(57) ABSTRACT

Systems and methods for associating cohorts in a social networking environment are provided. At least two users of a social network can be associated in a cohort based at least in part on a determined relationship between the at least two users. This relationship can be different from relationships defined by the users. An analysis of one or more parameters of the at least two users in the cohort can be performed based at least in part on the cohort, wherein the one or more parameters are unrelated to association of the at least two users in the cohort. The parameters can be used to longitudinally measure parameters of the at least two users that may have been impacted by association in the cohort. At least a portion of the analysis can be communicated.

### CROSS-REFERENCE TO RELATED APPLICATIONS

The present application for patent claims priority to Provisional Application No. 61/531,614, entitled “ONLINE LEARNING COLLABORATION SYSTEM AND METHOD” and filed Sep. 6, 2011, which is expressly incorporated by reference herein.

### TECHNICAL FIELD

The present disclosure relates to improvements in social networking and other internet enabled environments to support learning or other collaboration objectives and associated data collection and use for analytical purposes.

### BACKGROUND

Network or Internet-enabled environments generally, and email, collaboration, and social networking systems more particularly, typically allow users to communicate or interact online about various topics and categories of information. Permission-based systems normally set “static” permissions and rights for each user that define how the user interacts with the system and other users. A user may, as permitted or invited, join one or more groups of users formed within the system, where the user is then defined as being a part of the group(s). Communication between or among members of groups, and between or among members of different groups, is enabled or controlled by sets of rules. For example, a set of rules may specify that members of a “Group A” can communicate only among themselves (and perhaps communications or posts may or may not be seen, as opposed to interacted with, by members of other groups; members of a “Group A” may communicate with members of a “Group B,” but cannot communicate with members of a “Group C.” Typically, default permissions may be configured in some manner by an administrator or a group “owner” to allow communications not specifically disallowed, or to disallow communications not specifically allowed. Controlling access to communications and/or other access to information about members or posted by members is especially important in compliance driven environments where corporate, legal or social policies may relate to such people or information. Specific example of this relate to systems that involve children and/or schools (particularly K-12 schools and K-12 aged children, where, for example, there are a host of legal restrictions and policy-based practices in the US and around the world concerning communications by, to, and/or among children and/or in school-based setting (such as with children 13 years of age and under, restrictions relating to educational records, privacy, and the like).

In the context of learning and education, learning management systems (LMS) have been developed to allow interaction (sometimes using “social networking” principles) and association of various users in an online environment having such controls in place. For example, an educational structure or hierarchy can be captured by the LMS reflective of desired structure such as the organizational hierarchies in the real world. For example, district “groups” or users are created that associate a plurality of schools, each school having associated with it one or more groups of faculty and students (and/or parents), and one or more further groups that may be defined by enrollment, placement, invitation and/or participation in other groups based on desired criteria such as classes students are enrolled in or to which they are placed or “invited” to join, professional development groups, related associations (like the parent teacher association (PTA)), clubs, etc. This includes groupings by school, by grade, by classroom, etc.). Additional groupings can be established as well, such as associating users for projects of certain kinds (hereafter, a “project group”). Communication (such as posts and other forms known to one of skill in the art) may persist (for example be accessible in various ways, accessible, stored or archived, etc.) among users in the LMS based on the defined structure and groups (such as forums or blogs and other tools where members can communicate, contribute, create or interact asynchronously or synchronously). For example: a teacher can communicate with students in a given class by uploading curriculum and posting on the “wall” of a class group; students can communicate with one another based on defined grouping, such as groups in of the same or similar class, similar activities, or other data about the user or their associations, etc.; parents of students can communicate with other parents (or with group owners such as educators or other members based on whether their children are in one or more same groups, etc.).

In any case, the organizational structure present in an LMS may be configured to include various levels or organizational/atomic units at vertical as well as horizontal levels, such as district, school, classroom, teacher, student, parent, volunteer, principal, etc. For instance, a teacher may have many students, and a student may have a half dozen teachers, several classrooms, and one school. The subject matter or information that may be associated with a user may include classes or groups (or aggregations thereof) into which enrollment or membership has occurred, e.g., language arts, biological sciences, physical sciences, mathematics, etc. Moreover, in organizations like social networks, groups may be spontaneously or dynamically created or deleted by users (including as permitted to do so), and users can be added or removed from certain groups over time. Importantly, however, such membership information or data about such membership information does not persist over time in accessible and flexible ways that allow valuable analysis of such data to make inferences and/or take actions such as suggesting alternatives, remediation, new groups and the like.

### SUMMARY

The following presents a simplified summary of one or more aspects to provide a basic understanding thereof to one of skill in the art. This summary is not an extensive overview of all contemplated aspects, and is intended to neither identify key or critical elements of all aspects, nor delineate the scope of any or all aspects. Its sole purpose is to present some concepts of one or more aspects in a simplified form as a prelude to the more detailed description that follows.

Aspects described herein are directed to providing cohort association in membership or collaborative networks in general and social networks in particular, for subsequent comparative analysis of or among users in a given cohort. The value of and multiple ways and methods of conducting cohort analysis is extensively described in literature on nearly every business and academic discipline. Cohort associations may be provided in membership or collaborative networks by, for example, manually or automatically adding users to a cohort association of some sort (in addition to actual groups they may be members of). This can be based on similarities between the users, common groups related to the users, common status factors among users and/or their relationship to other users, etc. and/or on criteria specified by another person, such as a researcher or evaluator, etc. The cohort association can be stored and can persist over time and/or be attached or associated with artifacts (such as posts or communications) of users added to a cohort association. The cohort can be determined or otherwise specified irrespective of a requested grouping by the users, or a system-generated grouping of the users. This can allow for comparative analysis of users in the cohort at a later time, which can allow for analyzing, studying, or drawing inferences about the cohort, related components, or associated items.

In a specific example applied to learning, in a learning management system (LMS), students participating in a given class, extra-curricular activity, etc., can be associated in a cohort. The cohort can persist for a period of time after the association was made or the participation in the group started and/or ceased, allowing study, examination or analysis of, for example, academic or professional performance many years later, or suggested paths toward improvement, remediation, and/or customization. In addition, the analysis of the subsequent performance can be manual or automated; for example, inferences can be drawn based on writing adeptness by automatically evaluating publications, social networking posts, etc. made by the user or users in the cohort or groups within which the users or subsets of users participated, or based on information to which such persons were exposed. Cohort association in this regard allows for immense possibilities in determining impact of certain past cohort associations and related activities on users in the LMS and/or suggestions for one or more users in the system or outside the system based in part on such data.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations may denote like elements, and in which:

FIG. 1 is an aspect of an example system for providing social networking functionality with cohort associations.

FIG. 2 is an aspect of an example system for creating cohort associations and analyzing users in the cohort associations.

FIG. 3 is an aspect of an example methodology for analyzing users in cohort associations.

FIG. 4 is an aspect of an example methodology for generating one or more cohort associations based on social networking system events.

FIG. 5 is an aspect of an example methodology for generating one or more cohort associations based on social networking system data queries.

FIG. 6 is an aspect of an example methodology for analyzing users in established cohort associations.

FIG. 7 is an aspect of an example methodology for generating cohort associations.

FIG. 8 is an aspect of an example system in accordance with aspects described herein.

FIG. 9 is an aspect of an example communication environment in accordance with aspects described herein.

FIGS. 10-14 are example user interfaces for establishing cohort associations for users of a social networking system.

Appendix A describes aspects of an example application programming interface (API) that can be used to provide aspects described herein.

### DETAILED DESCRIPTION

Reference will now be made in detail to various aspects, one or more examples of which are illustrated in the accompanying drawings. Each example is provided by way of explanation, and not limitation of the aspects. In fact, it will be apparent to those skilled in the art that modifications and variations can be made in the described aspects without departing from the scope or spirit thereof. For instance, features illustrated or described as part of one example may be used on another example to yield a still further example. Thus, it is intended that the described aspects cover such modifications and variations as come within the scope of the appended claims and their equivalents.

Described herein are various aspects relating to providing cohort associations in membership or collaborative networks in general and social networks in particular, which can include learning management systems. For example, a cohort association can relate to a grouping of users (students, teachers, parents, and/or any combination thereof) that is independent of membership in “social” groups defined by the users in the (social) networking system. The cohort associations (also referred to generally herein as “cohorts”) then can persist, and various aspects of the users in the cohorts (including information associated with such user) can be longitudinally monitored or otherwise analyzed (e.g., postings, articles, blogs, job positions, etc.) to determine how actions or experiences related to the cohort may have impacted the users. In one embodiment, the social networking system automatically creates cohorts for certain defined relationships or groupings of users to allow this grouping to persist over time instead of just long enough for the intended purpose of the grouping (e.g., the duration of the class, project, activity, etc.). In another example, the social networking system can allow manual definition of one or more cohorts. The social networking system keeps track of each cohort and the associations between the cohort, groups, and information such as courses over time as users come and go into groups, projects, classes, and courses, for example. It is, of course, understood that references to such terms can include virtual implementations of the terms (e.g., a virtual project or a virtual classroom established by the LMS).

Because the system can maintain persistent records of which user(s) is (are) part of which cohort(s), and because, in the preferred embodiment, every interaction is made by a specific authenticated user, the system is configured to trace the cohort to collaborative and/or social learning activity at various levels, and can aggregate statistics of the cohort regardless of current or future group membership or connectivity. The statistics can be aggregated even at an individual message and/or social networking post level. For example, the system allows longitudinal analysis of a teacher's students and their activities years later even though many, most or all of such users may no longer be in the same class or group. Such analysis can assist in measuring performance of one or more aspects of the users in a cohort, which can provide invaluable information to monitor trends or performance of established cohorts.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Artificial intelligence based systems (e.g., explicitly and/or implicitly trained classifiers) can be employed in connection with performing inference and/or probabilistic determinations and/or statistical-based determinations in accordance with one or more aspects of the subject matter as described hereinafter. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for generating higher-level events from a set of events and/or data. Such inference results in the construction of new events or actions from a set of observed events or stored event data, regardless of whether the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, etc.), for example, can be employed in connection with performing automatic and/or inferred actions in connection with the subject matter.

Furthermore, the subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it is to be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the subject matter.

Moreover, the term or is intended to mean an inclusive or rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and an as used in this application and the appended claims should generally be construed to mean one or more unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

Certain aspects embodiments of the present invention relate to online learning systems and methods. Additional information regarding online learning systems, networks, and methods may be found in U.S. patent application Ser. Nos. 11/937,499, 60/395,405, 60/395,406, 60/395,407, 60/395,409, 60/395,410, 60/671,125, 60/857,560, 60/857,570, 60/857,583, 61/051,673, 61/157,897, 61/251,187, and 61/441,262 and in U.S. Published Patent Application Nos. 2004/0103118, 2004/0103122, 2004/0103137, 2004/0111423, 2004/0122692, 2006/0253533, 2006/0253572, 2008/0176194, 2008/0319949, 2009/0070490, 2009/0305218, 2010/0318642, and 2011/0119598. The entire disclosure of each of the foregoing applications is hereby incorporated by reference as if set forth verbatim herein.

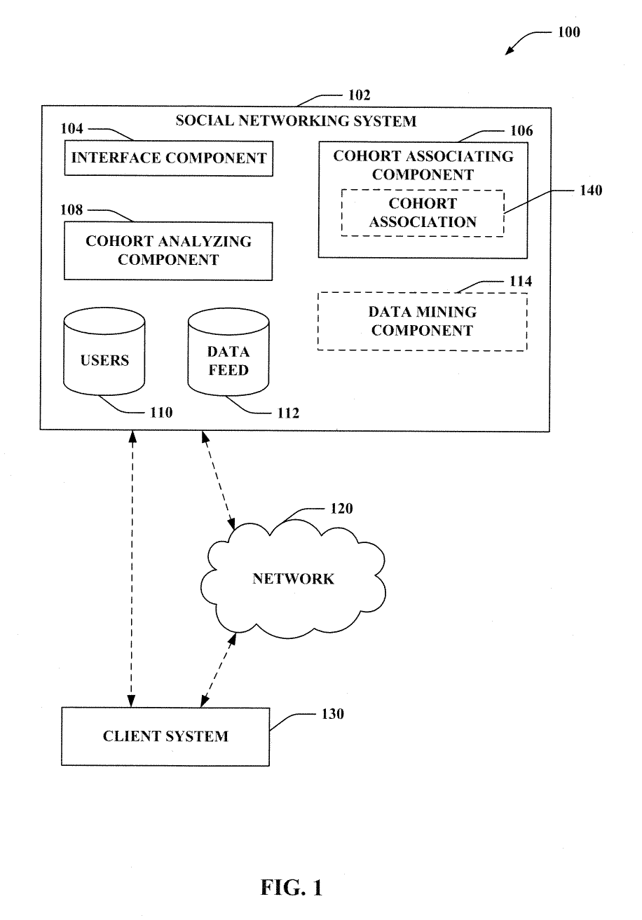

FIG. 1 illustrates an example system 100 including a social networking system 102 for managing not only users, associated relationships among the users, groups etc., but also cohorts of given users. Social networking system 102 can be a computing system or a collection of one or more computing systems distributed within a LAN, across the Internet, or over one or more other networks. For example, the components described herein can be implemented by various systems that communicate to form the social networking system 102. In addition, it is to be appreciated that social networking system 102 can include various other components, not shown or described, to perform functions typical of social networks; such components are not shown for ease of explanation.

Social networking system 102 includes an interface component 104 for allowing visual and/or programmatic interaction with components thereof, a cohort associating component 106 for associating users in cohorts and maintaining the associations, and a cohort analyzing component 108 for performing analysis of the users in a given cohort, which can be based on data unrelated to the cohort itself. Social networking system 102 additionally includes various databases, such as a users database 110, a data feed database 112, etc. that can store data typical of social networking systems, such as user profile information, user connections or other relationships, user groups, content for the user profile (e.g., content specified by related or grouped users), etc. Social networking system 102 can optionally include a data mining component 114 for observing data in one or more of the databases, which cohort associating component 106 can utilize to automatically create one or more cohort associations.

System 100 additionally includes a network 120, such as a LAN, Internet, mobile network, etc., and a client system 130 that can access social networking system 102 directly or over network 120. Thus, for example, client system 130 can be a computer, mobile device on a mobile network, etc., that can interact with social networking system 102 to determine information thereof or specify information thereto, such as user relationships or groupings, user cohorts, cohort analysis, etc.

According to an example, cohort associating component 106 can create a cohort association 140 between two or more users of users database 110. For example, cohort association component 106 can create the cohort association 140 based on specific cohort information received from interface component 104. For example, interface component 104 can allow for programmatic or interactive specification of the cohort information. In one example, client system 130 can provide a web-interface for specifying the cohort association information, and can provide the information to cohort associating component 106, which can be an application programming interface (API) or similar programmatic interface, to allow the specification by one or more computing systems. In any case, cohort associating component 106 can generate cohort association 140 as an entry in the one or more databases of social networking system 102. For example, the cohort association 140 can be represented by at least one of new information generated in a database (e.g., a cohort database) defining the cohort, such as entries in a table of a relational database that associate users of the social networking system 102 (or related identifiers) with a generated cohort (or related identifier), stale information in the databases, such as membership in an expired class, group, activity, etc.

In another example, cohort associating component 106 can automatically generate cohort associations 140 based on observations by data mining component 114 on user or system generated information in the social networking system 102. For example, data mining component 114 can monitor one or more databases (e.g., databases 110 and/or 112) of the social networking system 102 to observe modification thereto. In another example, data mining component 114 can query the databases (e.g., databases 110 and/or 112) to determine certain information related to one or more users, and cohort associating component 106 can use this information to generate cohort associations 140. In one example, data mining component 114 can determine stored or modified data in the one or more databases related to a user's groups, relationships, etc. in the social networking system, and cohort associating component 106 can create a cohort association 140 based on the data.

In a specific example, cohort associating component 106 automatically creates a cohort association 140 of students for each teacher per class, where social networking system 102 is an LMS. For instance, when a school district uploads data for a particular teacher to the LMS, the cohort associating component 106 groups the teacher's students for each class, for each term, and/or for each year into one or more cohort associations 140. In another specific example, a user can be added to a project group within a class in an LMS—this can be a system generated addition based on a teacher's indication of the project group, and/or the user can indicate the group membership. In one example, data mining component 114 detects the addition as a changed field in the users database 110 or a similar database. In another example, data mining component 114 detects the user as part of the project group based on querying the users database 110 or similar database. In either case, cohort associating component 106 can establish a cohort association 140 for the project group, and can add other members thereto, where data mining component 114 can similarly determine the other members based on detected modification to or querying of the users database 110 or similar database.

In another specific example, data mining component 114 can evaluate other databases or data sources to determine cohorts, such as a data feed database 112 or similar database that stores user generated content on the social networking system 102. Data mining component 114 can analyze the database, and cohort associating component 106 can infer cohort association 140 based on the analysis. For example, a user can post content related to a certain group, activity, event, preference, etc. (e.g., a post regarding what happened in an extracurricular activity, a post about a favorite music artist or genre, a post regarding happenings at home, etc.). Cohort associating component 106 can formulate cohort associations 140 based on detecting and filtering such information. Thus, for example, cohort associating component 106 can generate a cohort association 140 for users of a certain area (e.g., neighborhood, school, district, city, state, country, etc.) that post about classical music. Cohort associating component 106 can generate a cohort association 140 for users in an area that post favorably regarding siblings. The possible cohort associations 140 are immense.

Interface component 104 can be utilized to specify instructions for creating cohort association 140. For example, the interface component 104 can allow for specifying factors to indicate that users should be associated in a cohort. In one example, interface component 104 can be utilized to indicate users that post certain content to their profile should be associated in cohort association 140, and cohort associating component 106 can automatically generate and maintain the cohort association 140 via data mining component 114 determining such users on a realtime event basis and/or by querying the databases one or more times (e.g., based on an interval), as described further herein. Thus, the instructions can be specific as to what actions by or on behalf of the users result in association with a cohort. In another example, it is to be appreciated that third-party scripts or programs can be generated to utilize interface component 104 to operate data mining component 114, receive results, and define associations via cohort associating component 106.

In any case, the cohort associations 140 can persist for a long period of time (e.g., post-graduation), which can be longer than the existence of the actual cohort or related commonality among the users. Because the social network system 102 now has a record of which user is part of which cohort associations, and because in some examples every interaction is made by a specific authenticated user, cohort analyzing component 108 can subsequently trace the cohort to social learning activity at varying levels (e.g., including the individual message and/or post level) and can aggregate statistics by cohort association 140. For example, the cohort analyzing component 108 allows analysis of a teacher's students and what they are doing two years later even though they may no longer be in the same class or group. For instance, a cohort for an after school reading group at a school can persist for many years to allow analysis of future data regarding the users in that group. For example, perhaps the users of the group show a trend toward careers or further education in academia. Such analysis can provide valuable information regarding effectiveness of activities related to the cohorts. In one example, interface component 104 can additionally allow for specifying which databases of social networking system 102 (or outside the system 102) are to be mined by data mining component 114 for generating cohort associations 140.

Cohort analyzing component 108 can facilitate recalling and evaluating the cohort associations 140 for comparing data related to the users of one or more cohort associations 140. Cohort analyzing component 108 can perform automated analysis and/or analysis directed by a client system 130 via interface component 104. In an example, cohort analyzing component 108 can obtain a cohort association 140 from cohort associating component 106. This can be based on receiving a selection of the cohort association 140 from interface component 104 (e.g., based on selection using a user interface, selection specified by a program utilizing interface component 104 as an API, and/or the like). Cohort associating component 106 can then analyze one or more parameters of the users in the cohort to infer any possible relationships between the parameters and the previous association in a cohort. In the specific example above, cohort analyzing component 108 can obtain education or career parameters of the users, and can infer a possible association between users in or pursuing academia with a reading group cohort in elementary school.

As described, client system 130 can be utilized to analyze the cohort associations and related data, and can thus display data retrieved via interface component 104 for a user of the client system 130 to perform correlation analyses. In another example, cohort analyzing component 108 can automatically perform correlation analyses, and can provide conclusive results to the client system 130. Continuing with the example above, the cohort analyzing component 108 can provide career and higher education data to client system 130 for users in cohort association 140 related to the elementary school reading group for expert analysis, and/or can confirm the existence, degree, probability, etc. of a relationship between the elementary school reading group and careers or higher education in academia.

In another example, the parameters to be analyzed by cohort analyzing component 108 can correlate to publications or data feed posts created by the user or groups of users. For instance, a level of writing (e.g., word usage, grammar, etc.), an interest in certain hobbies, familial status, etc. can be inferred from data feed posts. This information can be analyzed for a certain cohort association 140 for automated or manual determination of a trend among the related users. In one example, such parameters can be used to associate or register the users to a class in a subsequent academic term (e.g., an advanced English class where a level if writing is determined to satisfy a threshold).

It is to be appreciated, in other examples, that third party scripts or programs can utilize interface component 104 for analyzing cohorts as well. For example, the scripts or programs can recall a cohort association 140 and parameters related to the users by using interface component 104 to access cohort associating component 106 to obtain the cohort association 140, and cohort analyzing component 108 to obtain the parameters of the related users. The scripts or programs can use the data to independently generate statistics or other output regarding the cohort association 140.

In one specific example, where social networking system 102 includes an LMS, a district administrator can utilize cohort associating component 106 (e.g., or a program or interface thereto) to create a cohort of teachers who had attended different professional development sequences or are national board certified teachers (or cohorts of related students under the teachers' instruction). The administrator can monitor the cohorts via cohort analyzing component 108 (e.g., or a program or interface thereto) to determine how many students associated with each cohort end up obtaining a higher level of education, such as proceeding to college versus the students associated with other cohorts of teachers. The LMS may also provide the ability to create a cohort across multiple school systems to aggregate and monitor the data associated with the cohort. For instance, cohorts may be used to compare the graduation rate of national board certified teachers across several districts and school systems with those that were not.

It is to be appreciated that cohorts may be used in other manners as well, such as to manage students in a class. For instance, where a new student joins a class in the middle of a year, cohort associating component 104 can clone a cohort association 140 related to that class, and the new student added to the cloned cohort association. Cohort analyzing component 108 can analyze both cohort associations to determine how the new student changed the class. Cloning cohorts allows for persistent groups and analysis of the data associated with the cohorts. Cohorts can span other groupings as well, as described.

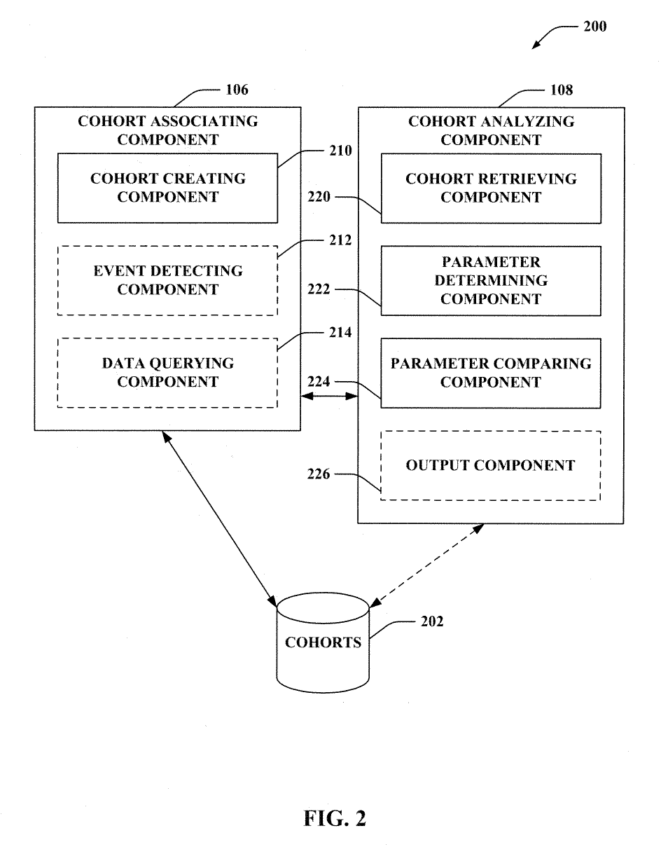

FIG. 2 illustrates an example system 200 for associating users in cohorts for subsequent analysis thereof. System 200 includes a cohort associating component 106 and a cohort analyzing component 108, which can be part of a social networking system, as described above. Cohort associating component 106 can create and store cohort associations in a cohorts database 202, and cohort analyzing component 108 can access cohorts database 202 (e.g., directly or through cohort associating component 106) to obtain information regarding one or more cohorts and/or users associated with the one or more cohorts. Cohort associating component 106 and cohort analyzing component 108 can each be provided by one or more local or distributed computers in a social networking system.

Cohort associating component 106 includes a cohort creating component 210 for generating a cohort that can be associated with a plurality of users, an optional event detecting component 212 that can determine occurrence of events on a user profile, and/or an optional data querying component 214 for obtaining user profile information from the social networking system.

Cohort analyzing component 108 can include a cohort retrieving component 220 for obtaining a cohort and/or related information such as users thereof, a parameter determining component 222 for obtaining one or more parameters of a profile of a user in the cohort, a parameter comparing component 224 for analyzing the users based on the one or more parameters, and/or an optional output component 226 for providing the user analysis to an interface.

According to an example, cohort creating component 210 generates a cohort for associating a plurality of users. This can occur without adding users to the cohort, in one example. The cohort can include information such as an identifier, qualifying criteria for the cohort, a description, a category, etc., all of which can be stored in cohorts database 202, in one example. Cohort associating component 106 can add users to the cohort based on detected events, determined user profile data, etc., as described. This can include adding the user, or an identifier thereof, to the cohorts database 202 (e.g., in a table or other structure relating to a given cohort association)

In one example, event detecting component 212 can determine whether one or more events related to a user profile qualify the user for the cohort association. Thus, in an example, cohort associating component 106 can monitor updates to user profiles (e.g., via a data mining component, as described) for certain criteria, such as joining a group, posting certain content to the social networking system, and/or substantially any event from which potential association to a cohort can be inferred, as described. This can include monitoring a data feed (e.g., a really simple syndication (RSS) feed) of various events occur on the social networking system, various events related to certain users or users of certain groups, etc.

For example, event detecting component 212 can aggregate the data feed at multiple levels (e.g., for a given user, a given class, a given school, etc.) and can use the aggregation to represent actual activity in the social networking system. In one example, the data feed can include information pertaining to social networking posts and conversations. Event detecting component 212 can aggregate feed data from multiple sources related to a given user, in one example. In some examples, semantic parsing routines can be used parse feed content to identify possible relationships among users (e.g., based on recipients or readers of certain posts, common strings or parameters of posts by given users, etc.). In this regard, the cohort associating component 106 can identify semantic intersections in the aggregated data feed to provide some metric of relevance or degree of separation to the intersection, and can determine whether to associate users in a cohort based on such.

In a specific example, weights may be applied for multiple metrics as well. For instance, event detecting component 212 can weigh words in the aggregated data feed by context (e.g., whether the words are from a forum, wiki, comment, etc.), relevance to topic (e.g., if the topic is The Raven, how likely is cigarettes as a word/concept applicable to the subject), relevance to data provided in a user's profile data (e.g., interest lists), distance to another user (e.g., degree of relational separation, location, etc.), likelihood that the words are slang, etc. Cohort associating component 106 can use the weights in determining whether the words, as weighted, satisfy requirements for cohort association.

In another example, data querying component 214 can query one or more data sources associated with the social networking system to obtain one or more parameters of a user profile. For example, the data source can be a user profile database, a data feed at a snapshot in time, and/or the like. Such querying can allow for creating cohort associations based on user profile history, as opposed to listening to current data feed updates, as described with respect to event deleting component 212. It is to be appreciated that both forms of monitoring can be used in determining parameters of user profiles.

Based on the parameters observed by event detecting component 212 and/or data querying component 214, cohort associating component 106 can determine whether user profiles satisfy criteria of the cohort association. For example, if event detecting component 212 detects that a user joins, or is otherwise added to, a group, cohort associating component 106 can determine whether the group correlates to a cohort association. If so, cohort associating component 106 associates the user profile with the cohort association that correlates to the group. In one example, inferences can be made regarding whether the user profiles satisfy cohort criteria based at least in part on detected events and/or data queried in the social networking system. It is to be appreciated that cohort association and creation can be additionally or alternatively performed manually via an interface, as described previously.

Cohort retrieving component 220 can subsequently retrieve one or more cohort associations for analyzing how actions or information concerning the cohort impacted related users over time. In one example, retrieving the cohort associations can occur much later in time than when the cohort association was created (or at least since the data from which the cohort association was created occurred). Once a cohort is retrieved, parameter determining component 222 can obtain parameters of the users of the cohort, which can be unrelated to the cohort itself, and parameter comparing component 224 can analyze the parameters of at least a portion of the users to draw one or more inferences of the cohort. For example, the inferences can be based on one or more rules regarding the parameters (e.g., if 50% of the users in a cohort for a second grade reading study group pursued higher education, it may be inferred that the study group had an impact on those users). Such rules can be defined by or using cohort analyzing component 108, a third party script or application, and/or the like, such that users can be analyzed based on the rules to make desired inferences.

In this regard, retrieval and analysis of the information can be manually performed by an expert using an interface, and/or rich statistical modeling can be performed by scripts or programs that can access an API into the cohort analyzing component 108, as described.

As described, certain aspects can relate to the social networking system as an LMS. In one embodiment, when the data is uploaded from a school system as explained above, the LMS provisions not only accounts for users, but also course information, course enrollment, social grouping and other information. That is, classes may be automatically provisioned for each teacher, which is also associated with a social group that is the classroom associated with the teacher. In one embodiment, the LMS identifies the classroom group as a type “class,” which allows the system to automatically create a moodle course, and cohort associating component 106 can automatically provision a cohort of all the students across all of their classes and/or a cohort for each class as well. A “moodle” in this instance can refer to a typical LMS online course.

It should be appreciated that other groups may be created by the LMS or by administrators or other users, such as the Parent-Teacher Associates (“PTA”), student voices, and teachers' lounge. The LMS provides the use of information that may be grouped into “collections,” which may be associated with teachers, other users, classes, groups, etc. and include content for the LMS, such as the content provided by the Smithsonian and National Geographic and/or available over a network. The collections may also include other content users may contribute or wish to use in their respective classes, groups, or cohorts. For instance, a teacher may create a project and then incorporate content from the collections into a chosen cohort, group, etc. Students may be grouped into the project and can then perform collaborative work using standard web 2.0 tools.

The LMS also provides “connections” to each user, which are the other users they are able to “see” that may be filtered based on discoverability, profile, or security rules instigated by the LMS. The LMS is policy managed; that is, in some examples all of the interactions in the LMS are policy managed, such as the communication between two users or the posting of information to a blog by a single user. Discoverability matrices are stored in the system's database(s) and include pairwise comparisons of user versus an item, such as another user, a project, a class, a group, etc. The comparisons determine whether a user is able to perform an action, like take part in an activity feed or a blog, or consequences of actions such as filer, moderate, store and other processes. The LMS analyzes the discoverability matrixes before performing the action to ensure the user is allowed to perform that action or to see people, groups, content, etc. or that the proper consequences occur.

As explained above, during provisioning of the data from the school system, the LMS derives relational data based on the enrollment data contained in the data from the school system. For instance, a school system provides course enrollment information, which the LMS of the presently-described embodiment analyzes to create social groupings. Also as explained above, the LMS also creates and/or acts on membership data or visibility rules, such as students can only see students in their school, parents can only see their own kids, teachers can see any other teacher in the district, ay member that is a member of the same group can see the person in their group, etc.

In the course of the LMS, users collaborate on projects, where members in the project come and go, and the project is eventually completed, or the users leave the project. As another example, students in a teacher's class are part of the group associated with that class, but eventually graduate and leave that class. The LMS can allow cohort associations, however, to remain persistent, even after the user graduates or the project terminates. It should be understood that this enables a host of downstream activities and analysis, such as assessment and further management of groups of students. The LMS can allow a teacher to form subgroups within her main group, such as a class. This allows the user to break apart the class into smaller groups, which, in one embodiment, may be automatically created for each teacher for each set of students. Moreover, cohorts may persist as the user comes and goes from groups of which the user is no longer a member or a course completed by the user. The cohort association continues to persist and can identify who was in that cohort regardless of what happens to the group, class, or users associated with the cohort. This provides traceability in the whole database of the LMS, as described herein. That is, the LMS may keep track of subsequent posts, communications, or activities for the entire cohort and the participation of the cohort members. As a result, the LMS allows the aggregation, evaluation, and assessment the data associated with a cohort.

A practical effect of a cohort can be the grouping of users into a social group or into a course to keep the data associated with the users and the groups in a persistent state. For instance, the LMS provides the ability to associate videos, blogs, forums, wikis, etc. with classes, projects, assignments, etc. A cohort may be the group that participates in an assignment and makes use of the blogs, forums, and wikis by posting information. The users may then complete the assignment and eventually be removed from the group associated therewith, such as the class. Cohorts, however, provide the ability to retain the association of the users to each other, the class, the assignment, and/or the activity.

When a user creates a new group, the group is created where the user has permission to create a group. If the group is a type “class” or “project,” the LMS may provide the ability to associate a cohort with the group via cohort associating component 106. One reason for this is convenience of enrollment. In social networks, the user receives an individual invitation that (s)he either accepts or rejects and individuals are invited to groups. That is, social networks are typically very user-centric, and based on the invite-request model. That methodology, however, creates a burden on a teacher who desires to quickly and easily put all of the students associated with the teacher into groups and associated subgroups with projects. The sequencing is that the user creates a group, selects one or more cohorts, and associates the cohort(s) with the group via cohort associating component 106. That association can cause the members of a social group and, if it's a class or a project, also enrolled in a corresponding moodle course. Thus, this process creates the cohort and maintains the traceability between the cohort.

Those skilled in the art should appreciate the database schema of the LMS may be updated to accommodate the association of cohorts with groups and users. That is, the purpose of that portion of the database schema is to enable the maintenance of the relationship of the cohort to a group. Fields can be provided for mapping relationships between cohort groups and items, so the LMS may return to the relationships and retrieve any of the activity, assignment submissions, or other things that might have happened within the group by a member of a cohort or by the whole cohort. Once the LMS stores the data in the database, it can be selected in different manners for aggregation and assessment.

From a manager's (for example a teacher's) point of view, cohort association can allow such person to perform small group instruction within a social learning platform as well as a standard LMS platform. Currently, in existing social networks, a user is either a member or not a member of a given group. There is no meaningful notion of being a subcohort within a group. In a typical LMS, a user is either enrolled in a course or not enrolled in the course. The ability to create the digital small group instruction through creating cohorts allows the system to collect everyone participating in a project. The cohorts, however, can be the students learning at different levels or the material or assignments can be different by cohorts.

It should also be appreciated that the ability to create and manage cohorts as explained above supports the ability to longitudinally assess over time and to track individual performance. If a cohort is associated with an item, such as a project that has a unique ID throughout the system, and further associated with a cohort which creates the membership in the group, then if a user provides a blog posting, the posting is associated with the user as a member of the cohort for an extended period of time.

It should be further understood that a cohort can work as a subset of a group, meaning there can be a smaller number of users in the cohort than are present in a group to which that cohort relates. Cohorts may also work in reverse. For instance, if a teacher teaches four similar history classes, a cohort may be created via cohort associating component 106 with all the students from the four classes in order to gain efficiencies and/or minimize duplication of providing information to or about the students.

LMSs, such as moodle or blackboard, typically include standard management capabilities for courses, course enrollment, assignments, lessons, due dates, grades, etc. With the addition of cohort capabilities as described herein, however, an enrollee's (such as a specific students' comments, posts and activities may be maintained, as well as the history of feedback the student receives form the teacher giving rise to a new and valuable set of capabilities that go far beyond management. Taking advantage of standard LMS capabilities. such as assignments or other data structures, messaging and dialogue between or among users and new content generated as a result of assignment or otherwise related to an assignment can be associated with it, providing further contextual data and therefore more granular and fine grained assessment and other capabilities. Thus it should be understood that system objects generated within the system can have other user/cohort related data associated with them providing even more robust capabilities.

In one embodiment, the LMS allows information and data associated with cohorts to be aggregated and tracked by cohort analyzing component 108. The LMS then provides the ability to cohort and look at activity by cohort, whether social activity, user generated data such as posts inside or outside of group-based contexts, or other more traditional data such as enrollment, subject matter, grade, assignments and other work artifacts that are created, turned in, scored and/or graded. Cohort analyzing component 108 can also evaluate the cohort in terms of the complexity, word choice, fluency, skill level, appropriate/depth of use of vocabulary, etc. as evidenced by the content of their work, posts, publications, and other activities that are used or associated with the cohort or portions thereof to gather substantial information an understanding of concepts, effect of stimuli on information recognition and activation, etc. In some examples, the LMS then provides the ability to look at the activity, such as the post itself or the messaging stream, and perform an analysis on that thread.

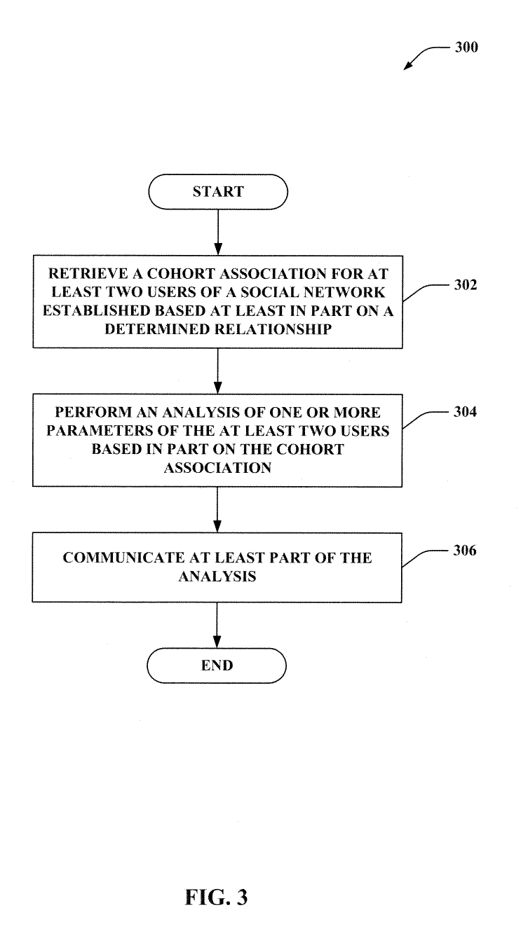

Referring to FIGS. 3-7, example methodologies relating to generating cohort association and/or subsequent analyses thereof are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

FIG. 3 illustrates an example methodology 300 for analyzing cohort associations. At 302, a cohort association for at least two users of a social network established based at least in part on a determined relationship can be retrieved. As described, the determined relationship can be other than a user-initiated relationship (e.g., a friend added by the user in the social network) and can be an automatic association based on membership of the users to a common group, similar filtered content posting performed by the users that may indicate association to a common group or interest, education level, etc. The cohort association can be retrieved from a database (e.g., by querying based on an identifier of the cohort association, one or more criteria used to qualify users to the cohort association, a portion of a description of the cohort association, etc.).

At 304, an analysis of one or more parameters of the at least two users can be performed based in part on the cohort association. For example, the parameters can be compared to determine any possible association or trend, as described. This can include retrieval of the parameters, analysis thereof to determine whether the parameters relate to a desired value or have some commonality, inferences based on complex statistical analyses regarding the parameters, and/or the like. It is to be appreciated that substantially any level of analysis can be performed and/or can be reserved for third-party applications.

At 306, at least a part of the analysis can be communicated. This can include communicating the retrieved parameters to a user interface or API, communicating a comparison of the parameters, communicating one or more inferences from statistical analyses, etc., as described. In any case, such cohort association allows for longitudinal analysis of users based on the cohort association, which can allow for determinations, assumptions, inferences, etc. to be made about efficacy of the cohort to produce an intended, consequential, or unintended result for the related users.

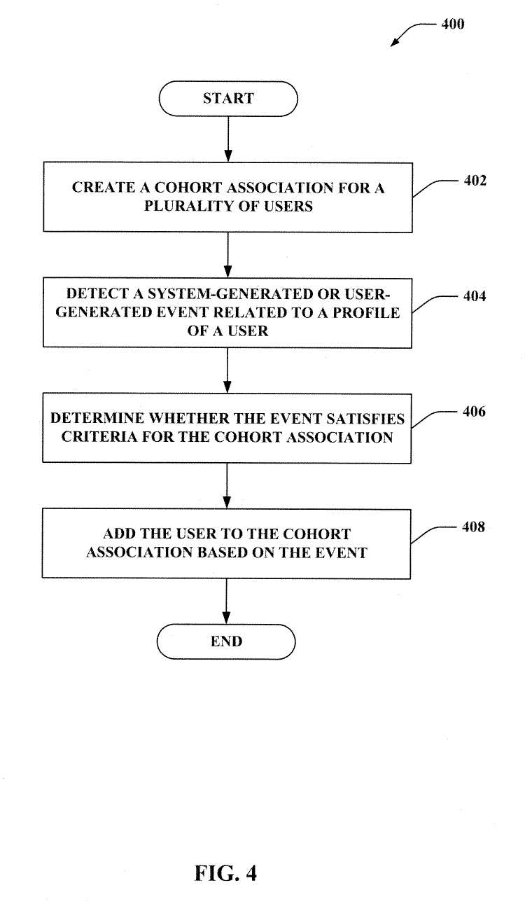

FIG. 4 illustrates an example methodology 400 for creating cohorts for a plurality of users. At 402, a cohort association can be created for a plurality of users. As described, the cohort association can have a collection of criteria for associating users, and/or can include an initial list of associated users. The cohort association can be created in a relational database related to a social networking system.

At 404, a system-generated or user-generated event related to a profile of a user can be detected. Such events can be detected based on monitoring a database for global modifications, modifications related to a certain user, group, or other entity, etc.

At 406, it can be determined whether the event satisfies criteria for the cohort association. This can include comparing a parameter of the event with a required parameter for the cohort association. For example, the parameter can relate to a string in a content post published by the user (e.g., “time.com” if the user shares a link to an article on time.com the user is associated in a cohort of time.com readers), a group joined by the user (Mr. Smith's sixth grade class of 1992, and thus the user can be in a cohort of time.com readers in Mr. Smith's sixth grade class of 1992 where both events occur), and/or the like.

At 408, the user can be added to the cohort association based on the event. For example, if the event satisfies the criteria for the cohort, the user is added to the cohort. Thus, the user can be considered in subsequent cohort association analyses (e.g., whether time.com readers in Mr. Smith's sixth grade class of 1992 have any similar profile parameters 20 years later).

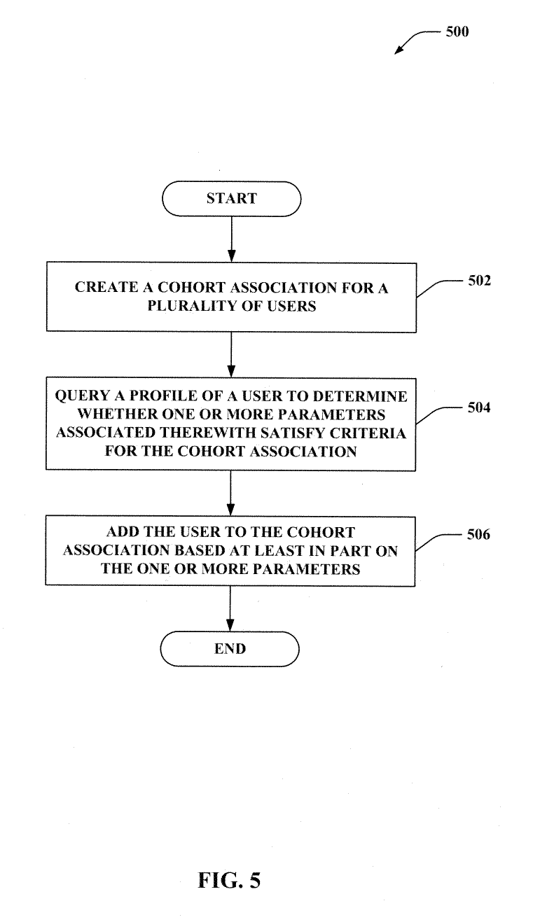

FIG. 5 illustrates an example methodology 500 for adding users to a cohort association. At 502, a cohort association can be created for a plurality of users. As described, the cohort association can have a collection of criteria for associating users, and/or can include an initial list of associated users. The cohort association can be created in a relational database related to a social networking system.

At 504, a profile of a user can be queried to determine whether one or more parameters associated therewith satisfy criteria for the cohort association. Thus, similarly to methodology 400, this methodology attempts to associate users to a cohort, but based on querying the profile instead of monitoring realtime events. The query can include querying one or more databases of a social network, analyzing a previous data feed, and/or the like. It is to be appreciated that a combination of these techniques can be used (e.g., upon detecting time.com in a posting string, the profile can be queried to determine whether the user is in Mr. Smith's sixth grade class of 1992).

At 506, the user is added to the cohort association based at least in part on the one or more parameters. For example, if the event satisfies the criteria for the cohort, the user is added to the cohort. Thus, the user can be considered in subsequent cohort association analyses.

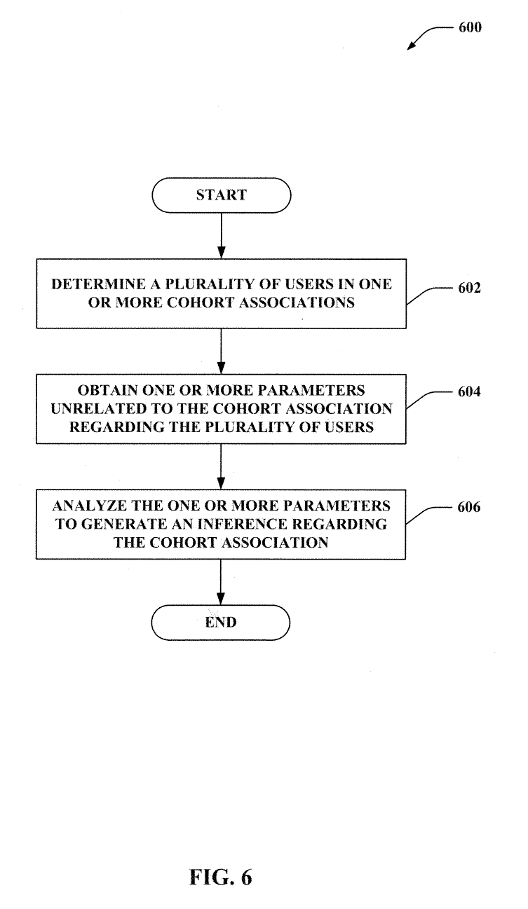

FIG. 6 illustrates an example methodology 600 for analyzing cohort associations. At 602, a plurality of users in one or more cohort associations can be determined. For instance, this can include determining an intersection of users specified for the one or more cohorts (e.g., determining at least identifiers of the users that can be used to determine one or more profile parameters of the users).

At 604, one or more parameters unrelated to the cohort association regarding the plurality of users can be obtained. The one or more parameters can relate to a current profile parameter of the plurality of users, where the cohort association occurred in the past and may be expired. The one or more parameters can be obtained from one or more databases of a social networking system related to the user.

At 606, the one or more parameters are analyzed to generate an interference regarding the cohort association. As described, the inference can be of varying levels of statistical complexity, and can relate to whether there are certain trends in the one or more parameters. From this information, conclusions can be drawn regarding the one or more cohort associations, as described.

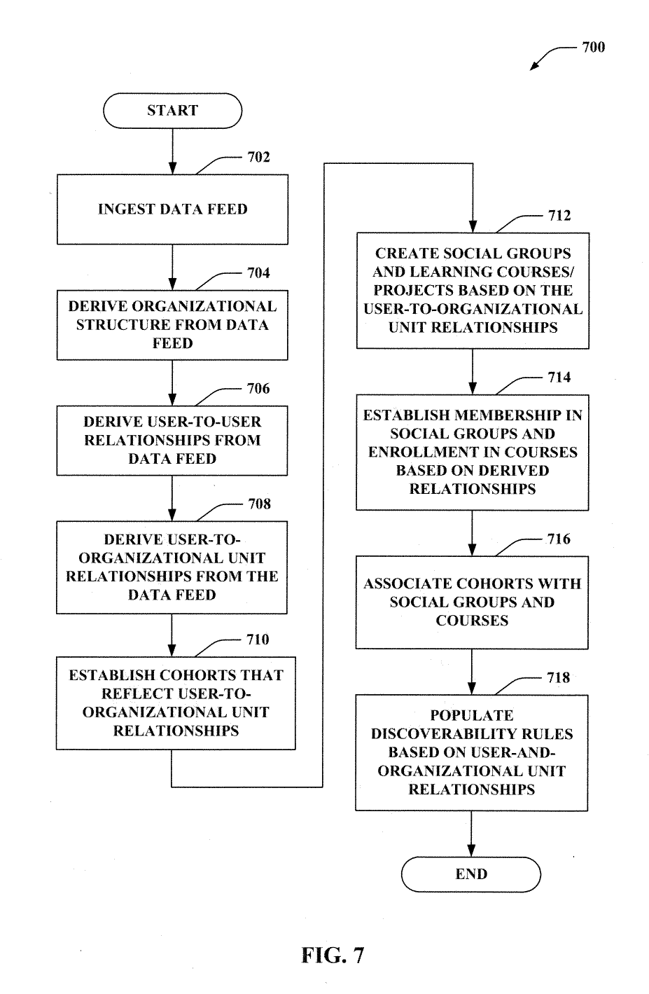

FIG. 7 illustrates an example methodology for generating cohorts. At 702, a data feed is ingested. This can include processing a snapshot of a data feed over a period of time, receiving a data feed in realtime or near realtime, etc.

At 704, organizational structure can be derived from the data feed. For example, the data feed can specify a schools established under a district, classrooms under the school, etc. in a data feed of an LMS. At 706, user-to-user relationships can be derived from the data feed. For example, the data feed can specify a teacher establishing a class with students, and thus a teacher-student relationship can be derived for the teacher and the various students in the class. At 708, user-to-organizational unit relationships can be derived from the data feed. Thus, the students can be derived as students in a class of a school in a district, etc.

At 710, cohorts can be automatically established to reflect user-to-organizational unit relationships. Thus, for example, a cohort can be created for students in a given class, activity, etc., teachers that teach in a given classroom, etc. The cohorts can be of varying granularity, as described, such that the cohorts can be longitudinally analyzed to determine trends or common parameters, etc. among the users in a given cohort. The automatically generated cohorts can persist over time, and can thus be analyzed many years from when the cohort existed, for example.

At 712, social groups and learning courses/projects can be created based on the user-to-organizational unit relationships. For example, students that were in a higher level reading class cohort can be grouped and/or placed in similar higher level classes in a next education term. Thus, at 714, membership in social groups and enrollment in courses can be established based on derived relationships. At 716, cohorts can be associated with social groups and courses. These associations can persist, as described, an can be analyzed to determine whether the social group or courses led the users of the cohort to exhibit similar profile parameters in the future. At 718, discoverability rules can be populated based on user-and-organizational unit relationships.

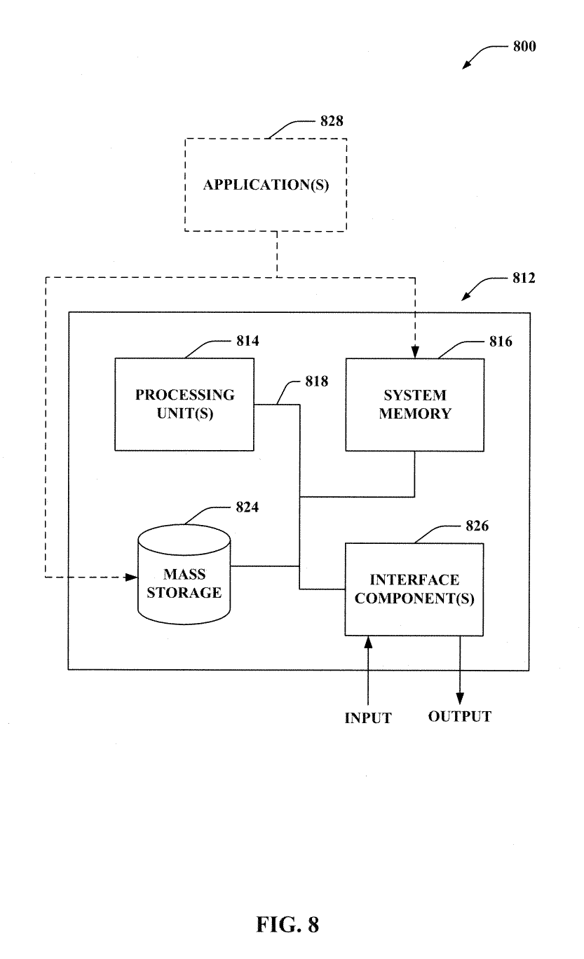

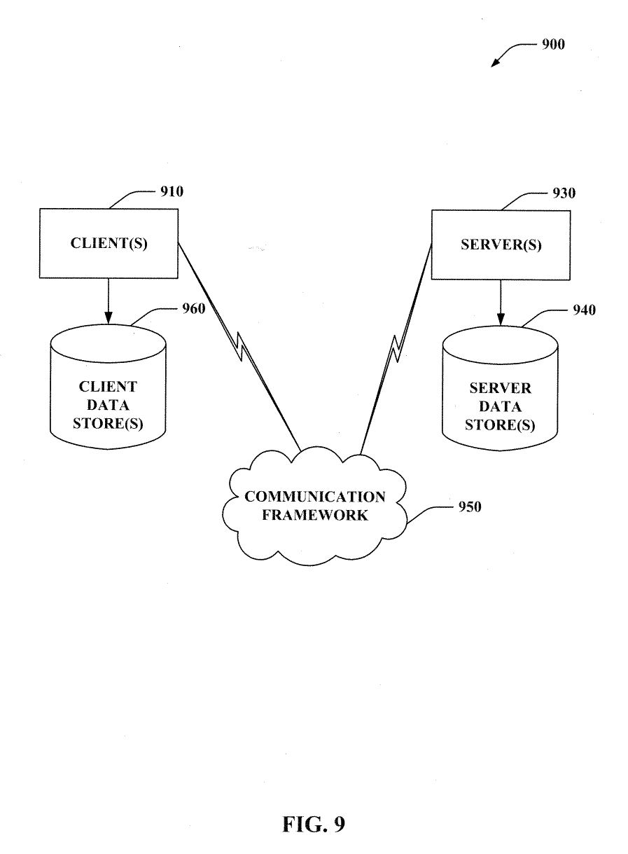

To provide a context for the various aspects of the disclosed subject matter, FIGS. 8 and 9 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 8, an exemplary environment 800 for implementing various aspects disclosed herein includes a computer 812 (e.g., desktop, laptop, server, hand held, programmable consumer or industrial electronics . . . ). The computer 812 includes a processing unit 814, a system memory 816 and a system bus 818. The system bus 818 couples system components including, but not limited to, the system memory 816 to the processing unit 814. The processing unit 814 can be any of various available microprocessors. It is to be appreciated that dual microprocessors, multi-core and other multiprocessor architectures can be employed as the processing unit 814.

The system memory 816 includes volatile and nonvolatile memory. The basic input/output system (BIOS), containing the basic routines to transfer information between elements within the computer 812, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 812 also includes removable/non-removable, volatile/non-volatile computer storage media. FIG. 8 illustrates, for example, mass storage 824. Mass storage 824 includes, but is not limited to, devices like a magnetic or optical disk drive, floppy disk drive, flash memory or memory stick. In addition, mass storage 824 can include storage media separately or in combination with other storage media.

FIG. 8 provides software application(s) 828 that act as an intermediary between users and/or other computers and the basic computer resources described in suitable operating environment 800. Such software application(s) 828 include one or both of system and application software. System software can include an operating system, which can be stored on mass storage 824, that acts to control and allocate resources of the computer system 812. Application software takes advantage of the management of resources by system software through program modules and data stored on either or both of system memory 816 and mass storage 824.

The computer 812 also includes one or more interface components 826 that are communicatively coupled to the bus 818 and facilitate interaction with the computer 812. By way of example, the interface component 826 can be a port (e.g., serial, parallel, PCMCIA, USB, FireWire . . . ) or an interface card (e.g., sound, video, network . . . ) or the like. The interface component 826 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 812 to output device(s) via interface component 826. Output devices can include displays (e.g., CRT, LCD, plasma . . . ), speakers, printers and other computers, among other things.

According to an example, the processing unit(s) 814 can comprise or receive instructions related to associating cohorts in a social networking system, analyzing cohorts, etc., and can receive related information from or provide related information to an interface component 826 (which can include an interface component, such as interface component 104), and/or other aspects described herein. It is to be appreciated that the system memory 816 can additionally or alternatively house such instructions and the processing unit(s) 814 can be utilized to process the instructions. Moreover, the system memory 816 can retain and/or the processing unit(s) 814 can comprise instructions to effectuate updating of the directory objects to ensure replication with one or more additional operating environments, for example.

FIG. 9 is a schematic block diagram of a sample-computing environment 900 with which the subject innovation can interact. The environment 900 includes one or more client(s) 910. The client(s) 910 can be hardware and/or software (e.g., threads, processes, computing devices). The environment 900 also includes one or more server(s) 930. Thus, environment 900 can correspond to a two-tier client server model or a multi-tier model (e.g., client, middle tier server, data server), amongst other models. The server(s) 930 can also be hardware and/or software (e.g., threads, processes, computing devices). The servers 930 can house threads to perform transformations by employing the aspects of the subject innovation, for example. One possible communication between a client 910 and a server 930 may be in the form of a data packet transmitted between two or more computer processes.

The environment 900 includes a communication framework 950 that can be employed to facilitate communications between the client(s) 910 and the server(s) 930. Here, the client(s) 910 can correspond to program application components and the server(s) 930 can provide the functionality of the interface and optionally the storage system, as previously described. The client(s) 910 are operatively connected to one or more client data store(s) 960 that can be employed to store information local to the client(s) 910. Similarly, the server(s) 930 are operatively connected to one or more server data store(s) 940 that can be employed to store information local to the servers 930.

By way of example, one or more clients 910 can define or request cohort associations to the server(s) 930 via communication framework 950. The server(s) 930 can leverage the server data store(s) 940 to determine parameters related to the cohort associations and/or related user parameters. The server(s) 930 can obtain the associations and/or related parameters and transmit such back to the client(s) 910 via communication framework 950. The client(s) 910, in one example, can store quotes (and/or market definition specifications) in the client data store(s) 960, for example.

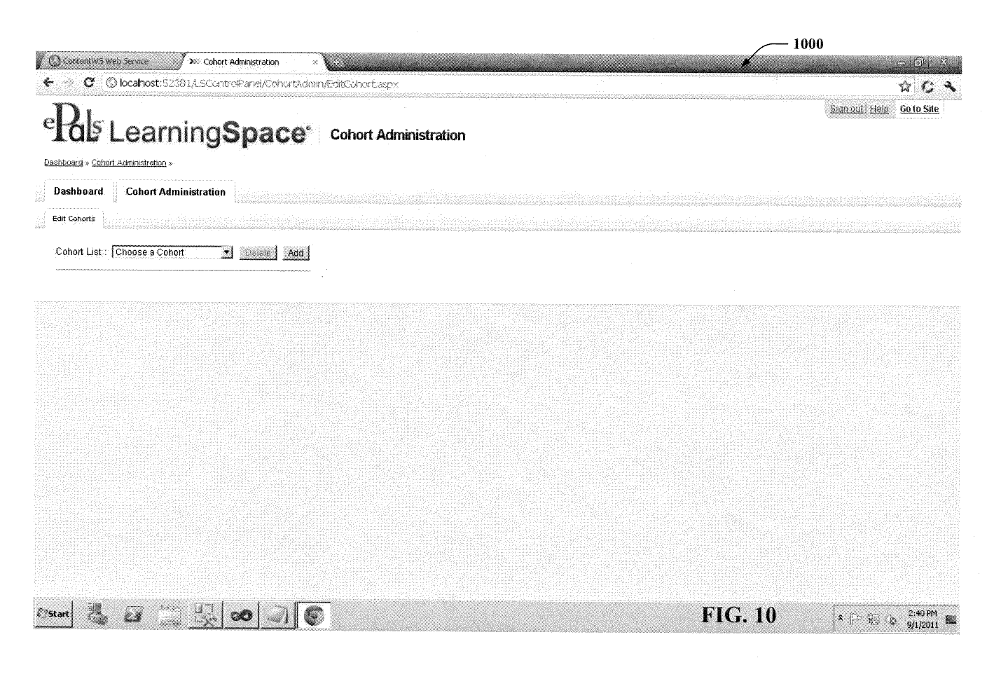

FIGS. 10-14 illustrate example user interfaces for managing cohort associations. For example, the user interfaces can be provided by an interface component, as described above, and can communicate with one or more databases or other sources to receive or modify cohort association information in a social networking system.

FIG. 10 illustrates an example user interface 1000 for adding, deleting, or selecting a cohort association. In addition, user interface 1000 has “Add” and “Delete” options for adding or removing one or more cohort associations, as described above.

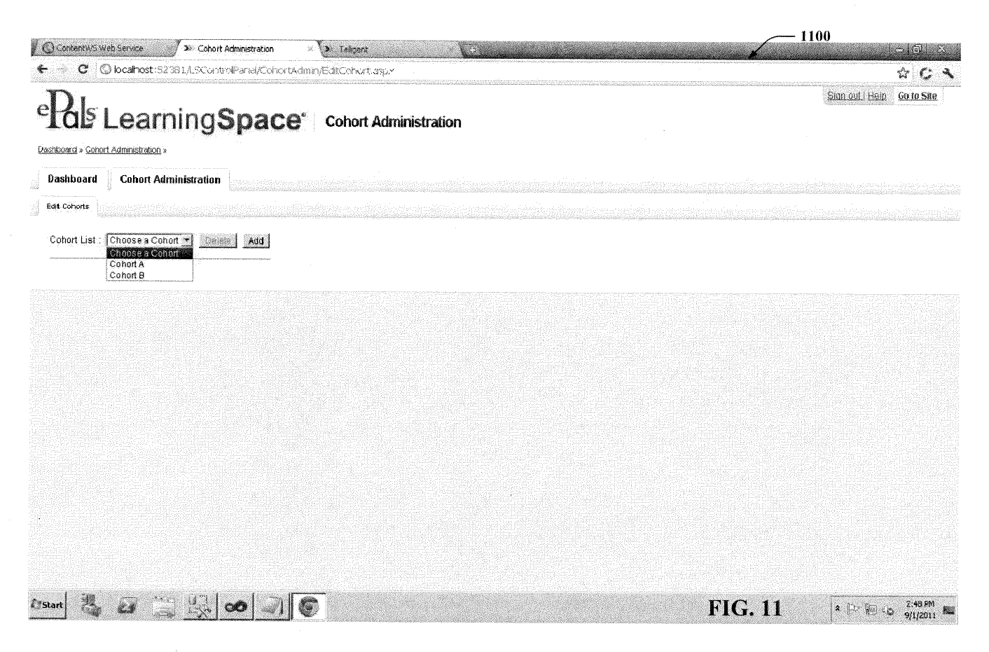

FIG. 11 illustrates an example user interface 1100 for selecting a stored cohort association for modifying or reviewing related information. As described, the cohort associations can be stored in a database accessible by the interface or one or more components with which the interface can communicate (e.g., a cohort associating component).

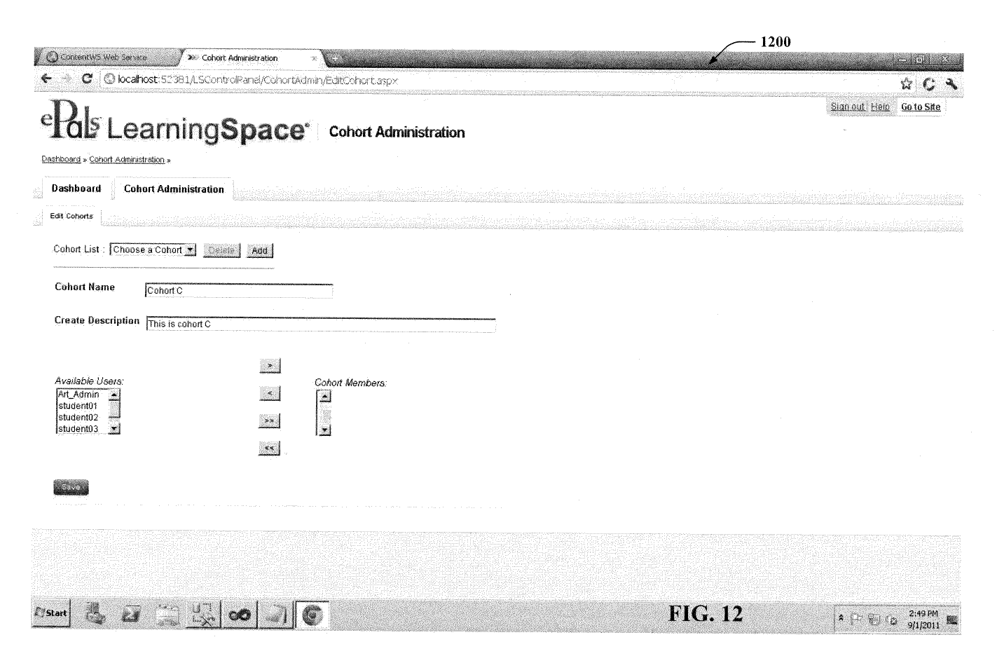

FIG. 12 illustrates an example user interface 1200 for modifying options of a selected cohort association, such as a cohort name, description, members, etc. For example, user interface 1200 shows a list of possible users that can be added to the cohort association, and at least a portion of the users can be selected for addition thereto.

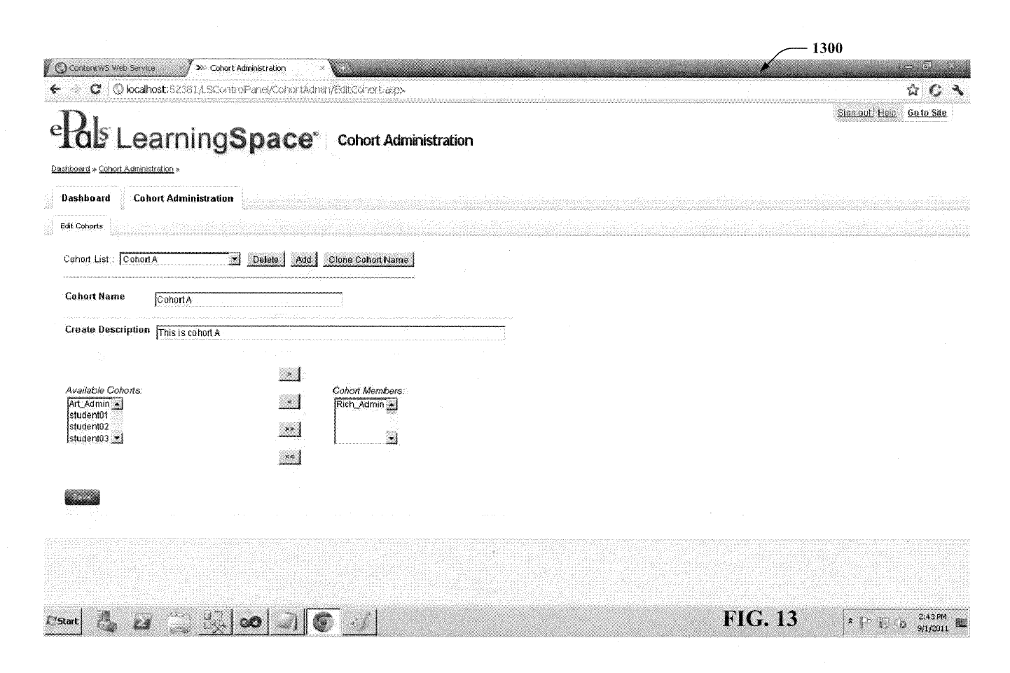

FIG. 13 illustrates an example user interface 1300 following addition of a user from the list of available cohorts to the list of cohort members.

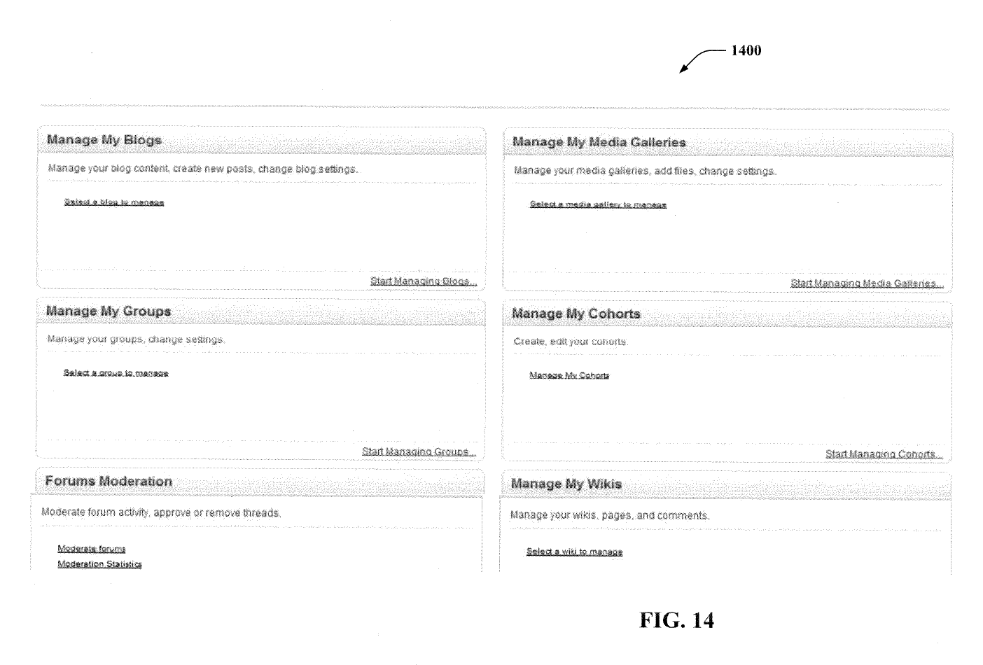

FIG. 14 illustrates an example user interface 1400 with various options of a social networking system, including a “Manage my Cohorts” option.

What has been described above includes examples of the subject matter described herein. It is, of course, not possible to describe every conceivable combination of components or methodologies for purposes of describing the subject matter, but one of ordinary skill in the art can recognize that many further combinations and permutations of the subject matter are possible. Accordingly, the present subject matter is intended to embrace all such alterations, modifications and variations that fall within the spirit and scope of the appended claims. Furthermore, to the extent that the terms “includes,” “has,” and “having” are used in either the detailed description or the claims, such term is intended to be inclusive in a manner similar to the term “comprising” as “comprising” is interpreted when employed as a transitional word in a claim.

What is claimed is:

1. A computer system for utilizing cohort associations in social networks, comprising:
a cohort associating component for associating at least two users of a social network in a cohort based at least in part on a determined relationship between the at least two users;
a cohort analyzing component for performing an analysis of one or more parameters of the at least two users in the cohort based at least in part on the cohort, wherein the one or more parameters are unrelated to association of the at least two users in the cohort; and
an interface component for communicating at least a portion of the analysis.

2. The computer system of claim 1, further comprising a data mining component for determining a common parameter of the at least two users based on querying the social network, wherein the cohort associating component associates based on the common parameter.

3. The computer system of claim 2, wherein the common parameter is one or more group memberships.

4. The computer system of claim 3, wherein the social network comprises a learning management system, and the one or more group memberships relate to a classroom.

5. The computer system of claim 1, further comprising a data mining component for detecting a modification of an aspect of a profile of at least one of the at least two users, wherein the cohort associating component associates based on detecting the modification.

6. The computer system of claim 5, wherein the modification correlates to the at least one user becoming a member of a group in the social network.

7. The computer system of claim 5, wherein the modification correlates to content posted by the at least one user on the social network.

8. The computer system of claim 1, wherein the analysis comprises an inference regarding the cohort based in part on comparing the one or more parameters.

9. The computer system of claim 1, wherein the cohort persists for a period of time after the determined relationship no longer exists.

10. A method for utilizing cohort associations in social networks, comprising:
retrieving a cohort association for at least two users of a social network established based at least in part on a determined relationship between the at least two users;
performing, using a processor, an analysis of one or more parameters of the at least two users in the cohort association based at least in part on the cohort association, wherein the one or more parameters are unrelated to the cohort association; and communicating at least a portion of the analysis via an interface.

11. The method of claim 10, further comprising associating the at least two users in the cohort association based at least in part on the determined relationship between the at least two users, wherein the cohort association persists for a period of time after the determined relationship no longer exists.

12. The method of claim 11, further comprising determining a common parameter of the at least two users based on querying the social network, wherein the associating occurs based on the common parameter.

13. The method of claim 12, wherein the common parameter is one or more group memberships.

14. The method of claim 13, wherein the social network comprises a learning management system, and the one or more group memberships relate to a classroom.

15. The method of claim 10, further comprising detecting a modification of an aspect of a profile of at least one of the at least two users, wherein the associating occurs based on detecting the modification.

16. The method of claim 15, wherein the modification correlates to the at least one user becoming a member of a group in the social network.

17. The method of claim 15, wherein the modification correlates to content posted by the at least one user on the social network.

18. The method of claim 10, wherein the analysis comprises an inference regarding the cohort based in part on comparing the one or more parameters.

19. A non-transitory computer-readable medium encoded with a program for utilizing cohort associations in social networks, the program comprising instructions for performing the steps of:
retrieving a cohort association for at least two users of a social network established based at least in part on a determined relationship between the at least two users;
performing an analysis of one or more parameters of the at least two users in the cohort association based at least in part on the cohort association, wherein the one or more parameters are unrelated to the cohort association; and
communicating at least a portion of the analysis via an interface.

20. The computer-readable medium of claim 19, wherein the program further comprises instructions for performing the step of associating the at least two users in the cohort association based at least in part on the determined relationship between the at least two users, and wherein the cohort association persists for a period of time after the determined relationship no longer exists.
